(19) United States
(12) Patent Application Publication
(10) Pub. No.: US 2026/0253444 A1
(43) Pub. Date: Aug. 27, 2026

(54) IMAGE ACQUISITION APPARATUS AND BIOMETRIC RECOGNITION DEVICE

(71) Applicant: TENCENT TECHNOLOGY (SHENZHEN) COMPANY LIMITED, SHENZHEN (CN)

(72) Inventors: Weibiao ZHOU, SHENZHEN (CN); Kai XIA, SHENZHEN (CN); Runzeng GUO, SHENZHEN (CN); Changze XIAO, SHENZHEN (CN)

(73) Assignee: TENCENT TECHNOLOGY (SHENZHEN) COMPANY LIMITED, SHENZHEN (CN)

(21) Appl. No.: 19/642,899

(22) Filed: Apr. 9, 2026

Related U.S. Application Data
(63) Continuation of application No. PCT/CN2024/123033, filed on Sep. 30, 2024.

(30) Foreign Application Priority Data
Jan. 23, 2024 (CN) 202420169363.7

(51) Int. Cl. G06V 40/10; G06V 10/141; G06V 10/147; G06V 40/13

(52) U.S. Cl. CPC G06V 40/117; G06V 10/141; G06V 10/147; G06V 40/1324

(57) ABSTRACT

The present disclosure provides an image acquisition apparatus and a biometric recognition device, belonging to the technical field of biometric recognition. The image acquisition apparatus includes: a light source, a reflective array, and an imaging component. The reflective array is located on a light exit side of the light source. The light source is configured to emit light toward the reflective array. The reflective array is configured to reflect the light toward a to-be-recognized palm to form at least one light spot pattern on the to-be-recognized palm. The imaging component is configured to receive the light reflected by a surface of the to-be-recognized palm and output a to-be-recognized image. The image acquisition apparatus of the present disclosure can avoid an attack of a planar non-living palm such as a paper print or a picture, thereby achieving a good liveness detection effect.

### RELATED APPLICATION

This application is a continuation application of PCT Patent Application No. PCT/CN2024/123033, filed on Sep. 30, 2024, which claims priority to Chinese Patent Application No. 202420169363.7 filed on Jan. 23, 2024, both of which are incorporated herein by reference in their entireties.

### FIELD OF THE TECHNOLOGY

The present disclosure relates to the technical field of biometric recognition, and in particular, to an image acquisition apparatus and a biometric recognition device.

### BACKGROUND OF THE DISCLOSURE

As convenient payment becomes increasingly integrated into daily life, various biometric recognition technologies are entering the field of identity recognition, and the trend of replacing conventional identity authentication methods with the biometric recognition technologies is becoming increasingly evident.

At this stage, the palm print and palm vein acquisition and recognition technology is gradually emerging as a biometric recognition technology that continues to attract widespread attention, with the development of corresponding biometric recognition devices, such as palm scanning devices.

### SUMMARY

The present disclosure provides an image acquisition apparatus and a biometric recognition device. The biometric recognition device can detect whether an object entering an image acquisition stage is indeed a live user rather than a paper print, a picture, a palm model, or the like, and exclude the object from a recognition process.

Technical solutions are as follows:

According to one aspect, an image acquisition apparatus is provided. The image acquisition apparatus includes: a light source, a reflective array, and an imaging component.

The reflective array is located on a light exit side of the light source. The light source is configured to emit light toward the reflective array. The reflective array is configured to reflect the light toward a to-be-recognized palm and illuminate the to-be-recognized palm, to form at least one light spot pattern on the to-be-recognized palm.

The imaging component is configured to receive the light reflected by a surface of the to-be-recognized palm and output a to-be-recognized image having the at least one light spot pattern.

According to another aspect, a biometric recognition device is provided. The biometric recognition device includes the image acquisition apparatus of the present disclosure.

The technical solutions provided in the present disclosure have at least the following beneficial effects.

The image acquisition apparatus of the present disclosure includes the light source, the reflective array, and the imaging component. Light emitted by the light source first illuminates a surface of the reflective array, and the reflective array reflects the light toward the to-be-recognized palm. On one hand, the to-be-recognized palm can be illuminated, so that the imaging component can obtain the clear to-be-recognized image. On the other hand, the reflective array forms the at least one light spot pattern on the to-be-recognized palm. When the light spot pattern is deformed to different degrees, the to-be-recognized palm is a non-planar surface, and it can be determined that the to-be-recognized palm is a real palm, so as to avoid an attack of a planar non-living palm such as a paper print or a picture, thereby achieving a good liveness detection effect.

### BRIEF DESCRIPTION OF THE DRAWINGS

FIG. 1 is a schematic structural view of an image acquisition apparatus according to an embodiment of the present disclosure.

FIG. 2 is a schematic view of a to-be-recognized image according to an embodiment of the present disclosure.

FIG. 3 is a schematic structural view of a reflective array according to an embodiment of the present disclosure.

FIG. 4 is a schematic structural view of an imaging component according to an embodiment of the present disclosure.

FIG. 5 is a schematic block diagram of a biometric recognition device according to an embodiment of the present disclosure.

### REFERENCE NUMERALS IN THE FIGURES

100, image acquisition apparatus;

200, image processing unit;

300, to-be-recognized palm;

400, recognition unit;

1, light source;

2, reflective array;

20, light spot pattern; 21, reflective array element; 22, driving unit;

3, distance sensor;

4, imaging component;

41, optical lens; 42, circuit board; and 43, photosensitive element.

### DESCRIPTION OF EMBODIMENTS

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The following implementations described in the following exemplary embodiments do not represent all implementations that are consistent with the present disclosure. On the contrary, the implementations are merely examples of an apparatus and a method consistent with some aspects of the present disclosure as detailed in the appended claims.

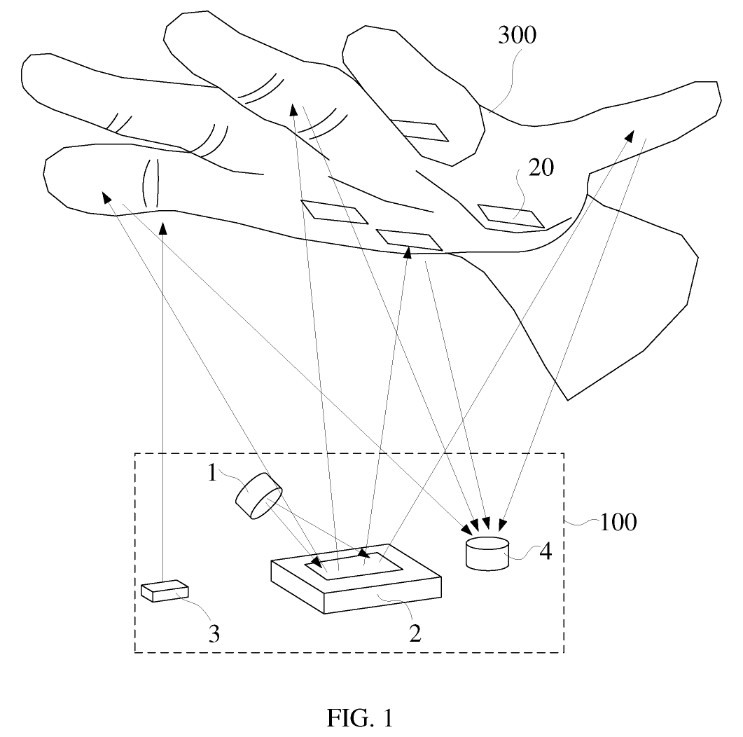

In the description of the present disclosure, orientation or position relationships indicated by the terms such as "center", "longitudinal", "transverse", "length", "width", "thickness", "upper", "lower", "front", "back", "left", "right", "vertical", "horizontal", "top", "bottom", "inside", "outside", "clockwise", "anticlockwise", "axial direction", "radial direction", and "circumferential direction" are based on orientation or position relationships shown in the FIG. 1, and are used only for ease and brevity of illustration and description, rather than indicating or implying that the mentioned apparatus or component necessarily has a particular orientation or is necessarily constructed and operated in a particular orientation. Therefore, such terms are not to be construed as limiting of the present disclosure.

In the present disclosure, "electrical connection" can be understood as physical contact and electrical conduction of components, or as a form of connection between different components in the circuit structure through a physical line capable of transmitting electrical signals, such as copper foil or a wire on a printed circuit board (PCB). "Communication connection" may refer to electrical signal transmission, including wireless communication connection and wired communication connection. The wireless communication connection does not need a physical medium and does not belong to a connection relationship limiting a product structure. "Connection" and "connected" may both refer to a mechanical connection relationship or a physical connection relationship. That is, that A is connected to B or A is connected to B may mean that there are fastening components (such as screws, bolts, rivets, and the like) between A and B, or that A and B are in contact with each other and are difficult to separate.

Unless otherwise indicated, all technical terms used in the embodiments of the present disclosure have the same meaning as commonly understood by a person of ordinary skill in the art to which the present disclosure belongs.

To make the objectives, technical solutions, and advantages of the present disclosure clearer, the following further describes implementations of the present disclosure in detail with reference to the accompanying drawings.

This embodiment relates to a biometric recognition device such as a palm scanning device. The palm scanning device includes a light source and a camera. The light source is configured to illuminate a palm. The camera is configured to capture a palm of a user, so that the palm scanning device can recognize palm features of the user and then confirm an identity of the user.

However, this biometric recognition technology has both advantages and disadvantages. Once a biometric feature is forged, serious losses will be caused. Therefore, how to add protective measures to the biometric feature becomes very important. How to make the palm scanning device detect, through technical means, whether an acquired object is indeed a live user, rather than a paper print, a picture, a palm model, or the like is the most important security protection means of the biometric recognition device.

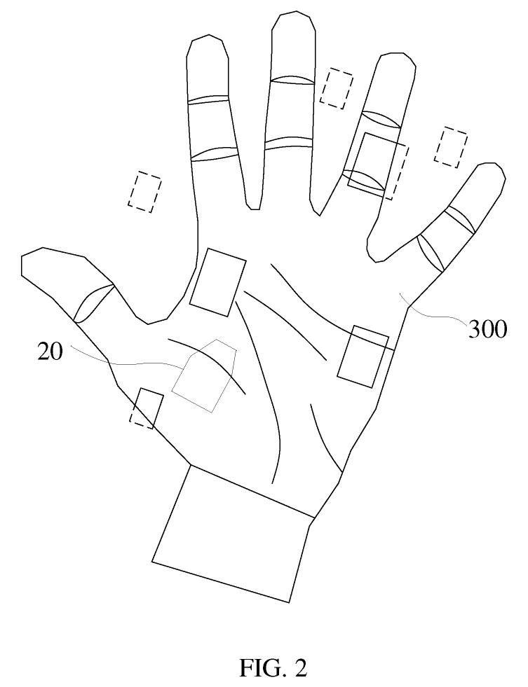

With reference to FIG. 1 and FIG. 2, this embodiment provides an image acquisition apparatus 100 of a biometric recognition device such as a palm scanning device. The image acquisition apparatus 100 includes: a light source 1, a reflective array 2, and an imaging component 4.

The reflective array 2 is located on a light exit side of the light source 1. For example, the reflective array 2 is located in a light exit path of the light source 1, and the light source 1 emits light toward the reflective array 2. A palm scanning window of the image acquisition apparatus 100 is located in a reflected light path of the reflective array 2, so that the reflective array 2 reflects light toward a to-be-recognized palm 300, illuminates the to-be-recognized palm 300, and forms at least one light spot pattern 20 on the to-be-recognized palm 300. The imaging component 4 is located in a reflected light path of the palm scanning window of the image acquisition apparatus 100, so that the imaging component 4 receives light reflected from a surface of the to-be-recognized palm 300 and outputs a to-be-recognized image having the at least one light spot pattern 20.

Specifically, the image acquisition apparatus 100 of this embodiment includes the light source 1, the reflective array 2, and the imaging component 4. Light emitted by the light source 1 first illuminates a surface of the reflective array 2, and the reflective array 2 reflects the light toward the to-be-recognized palm 300, so as to illuminate the to-be-recognized palm 300 and form the at least one light spot pattern on the to-be-recognized palm 300. The light illuminating the to-be-recognized palm 300 can further be reflected by the to-be-recognized palm 300 to the imaging component 4, so that the imaging component 4 can obtain the clear to-be-recognized image.

If the light spot pattern is deformed to different degrees, the to-be-recognized palm 300 is a non-planar surface, and further, it can be determined that the to-be-recognized palm 300 is a real palm. However, if the light spot pattern is almost not deformed, the to-be-recognized palm is flat, and further, it can be determined that the to-be-recognized palm 300 is a planar non-living palm. As a result, using the image acquisition apparatus for palm recognition can avoid an attack of a planar non-living palm such as a paper print or a picture, thereby achieving a good liveness detection effect.

In some embodiments, there are a plurality of light spot patterns, and the plurality of light spot patterns are arranged with each other according to a specific positional relationship. In this way, after the plurality of light spot patterns are projected on the non-planar to-be-recognized palm 300, a shape of each light spot pattern varies, and moreover, a distance between the light spot patterns varies due to the variations in surface curvature and depth of the to-be-recognized palm 300. In combination with the variation of each light spot pattern and the variation in the distance between different light spot patterns, shape data of the to-be-recognized palm 300 can be accurately obtained, and then the obtained shape data is compared with original data stored in a database, thereby further implementing recognition of the user identity.

In some embodiments, an area of the light spot pattern projected when a distance between the to-be-recognized palm 300 and the image acquisition apparatus 100 is a first distance is greater than an area of the light spot pattern projected when the distance between the to-be-recognized palm 300 and the image acquisition apparatus is a second distance. The first distance is less than the second distance, and the area of the light spot pattern refers to an area proportion of the light spot pattern on the palm.

For example, if the to-be-recognized palm 300 is close to the image acquisition apparatus 100, a plurality of the light spot patterns having a large area may be used for projection. This is because the to-be-recognized palm 300 is non-planar, and the shape of the to-be-recognized palm causes a significant difference in distance between each point of the to-be-recognized palm 300 and the image acquisition apparatus 100, which may cause deformation of the light spot, and the larger the light spot, the easier it is to distinguish the deformation.

However, if the to-be-recognized palm 300 is far away from the image acquisition apparatus 100, a plurality of the light spot patterns having a small area may be used for projection. This is because when the to-be-recognized palm 300 is far away from the image acquisition apparatus 100, it is difficult to distinguish deformation of the light spot pattern brought by a height difference of the shape of the to-be-recognized palm 300 (that is, the height difference generated by the non-planar surface of the to-be-recognized palm 300), but it is easier to distinguish the variation of the light spot pattern brought by a difference in depth of field of the to-be-recognized palm 300 at the edge.

For example, when the to-be-recognized palm 300 is close to the image acquisition apparatus 100, the reflective array element 2 may reflect a plurality of light spot patterns having a small area to the to-be-recognized palm 300. If the to-be-recognized palm 300 is a live palm, some of the light spot patterns fall outside the to-be-recognized palm 300 and have a large depth of field, and the other part of the light spot patterns fall on the to-be-recognized palm 300 and have a small depth of field. However, if the to-be-recognized palm 300 is a non-living palm that is printed or displayed on a screen, depths of field of all the light spot patterns are equal. Thereby, whether the to-be-recognized palm is a live palm or a non-living palm is determined according to whether depths of field of all the light spot patterns are equal.

Therefore, in this embodiment, using combinations of different light spot patterns and sizes of the light spot patterns in cooperation with the variations in shape of light spots or the difference in depth of field (light spot loss), the attack of a forged palm that is printed or displayed on a screen can be avoided, thereby achieving a good liveness detection effect.

In the related art, invasion and attack of a biometric recognition device by a non-living object typically involve the unauthorized use of images printed on paper or displayed on a screen. Because a non-living object presented on paper or a screen does not have depth space information, when a light spot pattern is projected on a plane, the light spot pattern is not deformed and is significantly different from a real palm. Therefore, the non-living object can be easily distinguished.

In some possible implementations, the light source 1 is a light-emitting diode (LED) light source, LEDs, or the like. For example, visible light or near infrared light is used. The visible light or the near infrared light can be emitted in a particular band at a specific angle, and can vary in brightness under driving of different currents and duty ratios to meet the requirements of the imaging component 4 for image acquisition.

In some possible implementations, the to-be-recognized image may include one or both of palm print information and palm vein information. For example, the to-be-recognized image may be palm print information or palm vein information.

The palm print information refers to various ridges on the surface of the palm from the fingertips to the wrist, and many features can be used for identity recognition, such as main ridges, wrinkles, fine textures, ridge endings, and bifurcation points. The form of the palm print is genetically determined. Even if the epidermis peels off for some reason, the newly formed palm print ridges retain their original structure. Different people have different palm print ridges. Even identical twins have palm prints that are only relatively similar, never completely identical. An identity of a person may be determined using ridge features, point features, texture features, and/or geometrical features of the palm print.

For the palm vein information, palm vein is a type of vein, specifically referring to the venous system in a human palm. When palm vein is used for identity recognition, image features of the palm vein, which are features that exist only in a live palm, are obtained.

In some other possible implementations, the imaging component 4 includes a red, green, and blue (RGB) camera or an infrared camera. The RGB camera may be configured to acquire color images with high accuracy. The RGB camera provides three basic color components using three different cables, and acquires three color signals using three independent charge coupled devices (CCDs).

In some possible examples, the image acquisition apparatus 100 further includes a protection cover plate. The protection cover plate is located among the reflective array 2, the imaging component 4, and the to-be-recognized palm 300. For example, the protection cover plate covers the palm scanning window of the image acquisition apparatus. For example, a base material of the protection cover plate needs to be a material having high light transmittance, such as polyethylene terephthalate (PET)/polycarbonate (PC)/polymethyl methacrylate (PMMA).

In some embodiments, a brightness of the at least one light spot pattern is different from that of other regions of the to-be-recognized palm 300. The other regions refer to regions other than the light spot patterns on the to-be-recognized palm 300. Differential light reflection may be performed on different regions using the reflective array 2. When the region in which the light spot pattern is located receives more reflected light, the light spot pattern appears brighter than the other regions, thereby forming the high-brightness light spot pattern.

In some embodiments, a shape of a projection of the at least one light spot pattern on a plane is at least one of a rectangle, a square, a triangle, and a circle.

Through the foregoing arrangement, the shape of the projection of the light spot pattern on the plane is a regular pattern. Therefore, the light spot pattern is significantly deformed after illuminating a non-planar surface of the to-be-recognized palm 300, which is more beneficial to measurement and confirmation of a deformation amount of the light spot pattern, so as to confirm the surface relief of the to-be-recognized palm 300.

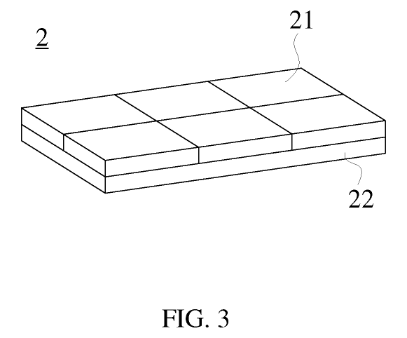

With reference to FIG. 3, in some embodiments, the reflective array 2 includes at least one reflective array element 21 and a driving unit 22. The at least one reflective array element 21 is connected to the driving unit 22. The driving unit 22 is configured to drive the at least one reflective array element 21 to move, to adjust a direction of the reflected light.

In some implementations, the driving unit may be a driving circuit (or a driving controller), which is configured to control/drive the at least one reflective array element 21 to move, so as to adjust a direction of the reflected light.

Through the foregoing arrangement, the reflective array 2 can reflect, using the reflective array element 21 thereon, light emitted by the light source 1 toward different directions. In this way, on one hand, the light can uniformly illuminate the entire to-be-recognized palm 300, and on the other hand, the high-brightness light spot pattern can be formed on the surface of the to-be-recognized palm 300 through the direction of light superposition.

For example, the reflective array 2 is a digital micromirror device (DMD). The DMD is an electronic-input optical-output micro-electro-mechanical system (MEMS). The DMD includes thousands of tiny movable micromirrors (that is, reflective array elements 21), and each micromirror corresponds to a pixel. The micromirrors are usually made of aluminum or silicon and have a size of 10 to 20 micrometers. Based on semiconductor manufacturing technology, the DMD includes a high-speed digital light reflection switch array, and determines an imaging pattern and features thereof by controlling rotation of micromirrors around a fixed yoke and time-domain response (determining a reflection angle and a stagnation time of light). Digital optical modulation on incident light and/or reflected light is implemented using a micromirror array and a fast switching mechanism.

With reference to FIG. 1, in some embodiments, the image acquisition apparatus 100 further includes at least one distance sensor 3. The at least one distance sensor 3 is located on one side of the imaging component 4. The at least one distance sensor 3 is configured to detect a distance between the to-be-recognized palm 300 and the reflective array 2 and a distance between the to-be-recognized palm 300 and the imaging component 4.

In this embodiment, the distance sensor 3 can detect the distance between the to-be-recognized palm 300 and the reflective array 2 or the distance between the to-be-recognized palm 300 and the imaging component 4. On one hand, the distance information is configured for detecting whether the to-be-recognized palm is located above the image acquisition apparatus 100. The image acquisition apparatus 100 is started only when it is confirmed that the to-be-recognized palm 300 is located above the image acquisition apparatus 100. On the other hand, the reflective array 2 can determine an accurate reflection direction according to the distance information. Moreover, the imaging component 4 can adjust imaging parameters according to different distance information.

The distance sensor 3 includes, but is not limited to, an infrared modulated spectral reflectance intensity sensing device and an infrared time-of-flight sensing device. For example, there are a plurality of distance sensors 3, and the plurality of distance sensors 3 may be respectively configured to detect a plurality of acquisition regions of the imaging component 4 and guide the reflective array 2 to reflect light based on positions.

With reference to FIG. 1, in some embodiments, the at least one distance sensor 3 is electrically connected to the light source 1, and the light source 1 is configured to adjust a light-emitting state according to the distance between the to-be-recognized palm 300 and the reflective array 2 and/or the distance between the to-be-recognized palm 300 and the imaging component 4.

In this embodiment, the distance sensor 3 is configured to detect different spatial positions of the to-be-recognized palm 300 above the image acquisition apparatus 100, so as to perform supplementary light compensation on the light source. For example, when the to-be-recognized palm 300 is close, the light source 1 requires a small amount of supplementary light. When the to-be-recognized palm 300 is far, the light source 1 requires a large amount of supplementary light.

With reference to FIG. 1, in some embodiments, the at least one distance sensor 3 is electrically connected to the reflective array 2, and the reflective array 2 is configured to adjust a reflection direction according to the distance between the to-be-recognized palm 300 and the reflective array 2 or the distance between the to-be-recognized palm 300 and the imaging component 4. The spatial position of the to-be-recognized palm 300 relative to the reflective array 2 can be determined using the distance sensor 3, so that the reflective array 2 can reflect light toward the to-be-recognized palm 300 and illuminate the to-be-recognized palm to form the light spot pattern.

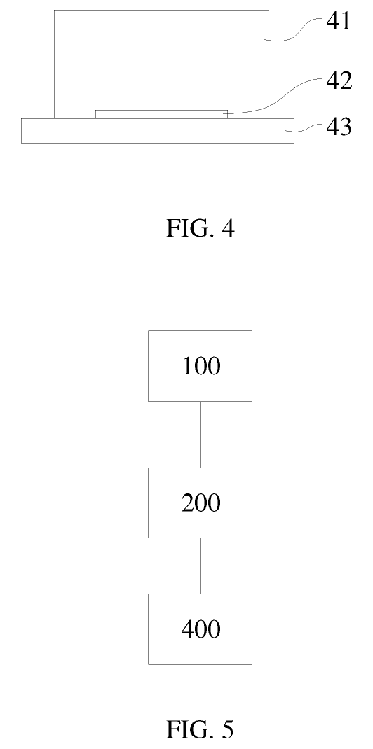

With reference to FIG. 4, in some embodiments, the imaging component 4 includes an optical lens 41, a circuit board 42, and a photosensitive element 43. The photosensitive element 43 is electrically connected to the circuit board 42. The optical lens 41 is located in a light entrance path of the photosensitive element 43.

In some possible implementations, the photosensitive element 43 is also referred to as an image sensor, which may be a complementary metal oxide semiconductor (CMOS) or a charged coupled device (CCD), or an image sensor of another type other than the CMOS or CCD, for example, a charge injection device (CID).

For the CMOS, a digital signal processor (DSP) may be integrated in the CMOS. The CMOS has advantages of high integration level, low power consumption, low cost, and the like, and is suitable for an electronic device with limited mounting space, such as a biometric recognition device and a mobile phone.

In some possible implementations, a printed circuit is disposed on a surface of the circuit board 42. The circuit board 42 includes a printed circuit board (PCB), a flexible printed circuit board (FPC), a rigid-flex board, and the like.

According to another aspect, with reference to FIG. 5, this embodiment provides a biometric recognition device. The biometric recognition device may be specifically a palm scanning device. The biometric recognition device includes the image acquisition apparatus 100 of the present disclosure. The biometric recognition device in this embodiment uses the image acquisition apparatus 100 of the present disclosure, and has all beneficial technical effects of the present disclosure.

With reference to FIG. 5, in some embodiments, the image acquisition apparatus 100 further includes an image processing unit 200. The image processing unit 200 is electrically connected to the imaging component 4. The image processing unit 200 receives the to-be-recognized image outputted by the imaging component 4 and determines a three-dimensional shape of the to-be-recognized palm 300 according to deformation of the at least one light spot pattern in the to-be-recognized image. Spatial parameter information of the to-be-recognized palm 300 may be restored using the image processing unit 200, thereby improving recognition accuracy and recognition efficiency of the biometric recognition device in the present disclosure.

In some implementations, the image processing unit may be an image processing circuit (or processor), which is configured to receive the to-be-recognized image outputted by the imaging component and is configured to determine a three-dimensional shape of the to-be-recognized palm according to deformation of the at least one light spot pattern in the to-be-recognized image.

Referring to FIG. 5, in some possible implementations, the biometric recognition device further includes a recognition unit 400. A plurality of candidate palm print images may be stored in the recognition unit 400. For example, the recognition unit 400 is a central processing unit (CPU) that can implement image processing.

The recognition unit 400 is electrically connected to the image processing unit 200, so that the recognition unit 400 can obtain the to-be-recognized image transmitted by the image acquisition apparatus 100. By comparing the to-be-recognized image with the candidate palm print images, the recognition unit 400 can determine a target identity corresponding to the to-be-recognized image.

"A number of” and "at least one" mentioned herein means one or more, and "a plurality of" and "at least two" means two or more. "And/or" describes an association relationship between associated objects and indicates that three relationships may exist. For example, A and/or B may indicate the following three cases: Only A exists, both A and B exist, and only B exists. The character "/" generally indicates an "or" relationship between the associated objects.

In the descriptions of this specification, descriptions with reference to terms "certain implementations", "an implementation", "some implementations", "an exemplary implementation", "an example", "a specific example", or "some examples" mean that specific characteristics, structures, materials, or features described with reference to the implementation or example are included in at least one implementation or example of the present disclosure.

In various embodiments in the present disclosure, a unit may refer to a software unit, a hardware unit, or a combination thereof. A software unit may include a computer program or part of the computer program that has a predefined function and works together with other related parts to achieve a predefined goal, such as those functions described in this disclosure. A hardware unit may be implemented using processing circuitry and/or memory configured to perform the functions described in this disclosure. Each unit can be implemented using one or more processors (or processors and memory). Likewise, a processor (or processors and memory) can be used to implement one or more units. Moreover, each unit can be part of an overall unit that includes the functionalities of the unit. The description here also applies to the term unit and other equivalent terms.

In some other embodiments, a computer-readable medium comprising instructions which, when executed by a computer, cause the computer to carry out a portion or all of the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software. In various embodiments in the present disclosure, the term “processor” may mean one processor that performs the defined functions, steps, or operations or a plurality of processors that collectively perform defined functions, steps, or operations, such that the execution of the individual defined functions may be divided amongst such plurality of processors.

The foregoing descriptions are merely embodiments of the present disclosure, but are not intended to limit the present disclosure. Any modification, equivalent replacement, or improvement made within the principle of the present disclosure shall fall within the protection scope of the present disclosure.

What is claimed is:

1. An image acquisition apparatus, the image acquisition apparatus comprising:
a light source, a reflective array, and an imaging component;
wherein:
the reflective array is located on a light exit side of the light source,
the light source is configured to emit light toward the reflective array,
the reflective array is configured to reflect the light toward a to-be-recognized palm and illuminate the to-be-recognized palm, to form at least one light spot pattern on the to-be-recognized palm, and
the imaging component is configured to receive the light reflected by a surface of the to-be-recognized palm and output a to-be-recognized image having the at least one light spot pattern.

2. The image acquisition apparatus according to claim 1, wherein:
an area of the light spot pattern projected when a distance between the to-be-recognized palm and the image acquisition apparatus is a first distance is greater than an area of the light spot pattern projected when the distance between the to-be-recognized palm and the image acquisition apparatus is a second distance;
the first distance is less than the second distance; and
the area of the light spot pattern is an area proportion of the light spot pattern on the to-be-recognized palm.

3. The image acquisition apparatus according to claim 1, wherein:
a shape of a projection of the at least one light spot pattern on a plane is at least one of the following: a rectangle, a square, a triangle, or a circle.

4. The image acquisition apparatus according to claim 1, wherein:
the reflective array comprises at least one reflective array element and a driving circuit; and
the at least one reflective array element is connected to the driving circuit, and the driving circuit is configured to drive the at least one reflective array element to move, to adjust a direction of the reflected light.

5. The image acquisition apparatus according to claim 1, wherein:
the image acquisition apparatus further comprises at least one distance sensor,
the at least one distance sensor is located on one side of the imaging component, and
the at least one distance sensor is configured to detect a distance between the to-be-recognized palm and the reflective array and a distance between the to-be-recognized palm and the imaging component.

6. The image acquisition apparatus according to claim 5, wherein:
the at least one distance sensor is electrically connected to the light source, and
the light source is configured to adjust a light-emitting state according to at least one of the distance between the to-be-recognized palm and the reflective array or the distance between the to-be-recognized palm and the imaging component.

7. The image acquisition apparatus according to claim 5, wherein:
the at least one distance sensor is electrically connected to the reflective array, and
the reflective array is configured to adjust a reflection direction according to at least one of the distance between the to-be-recognized palm and the reflective array or the distance between the to-be-recognized palm and the imaging component.

8. The image acquisition apparatus according to claim 5, wherein:
the imaging component comprises an optical lens, a circuit board, and a photosensitive element,
the photosensitive element is electrically connected to the circuit board, and
the optical lens is located in a light entrance path of the photosensitive element.

9. The image acquisition apparatus according to claim 1, wherein:
the imaging component comprises an optical lens, a circuit board, and a photosensitive element,
the photosensitive element is electrically connected to the circuit board, and
the optical lens is located in a light entrance path of the photosensitive element.

10. The image acquisition apparatus according to claim 1, further comprising:
an image processing circuit electrically connected to the imaging component,
wherein the image processing circuit is configured to receive the to-be-recognized image outputted by the imaging component and to determine a three-dimensional shape of the to-be-recognized palm according to deformation of the at least one light spot pattern in the to-be-recognized image.

11. A biometric recognition device, comprising an image acquisition apparatus comprising:
a light source, a reflective array, and an imaging component;
wherein:
the reflective array is located on a light exit side of the light source,
the light source is configured to emit light toward the reflective array,
the reflective array is configured to reflect the light toward a to-be-recognized palm and illuminate the to-be-recognized palm, to form at least one light spot pattern on the to-be-recognized palm, and
the imaging component is configured to receive the light reflected by a surface of the to-be-recognized palm and output a to-be-recognized image having the at least one light spot pattern.

12. The biometric recognition device according to claim 11, wherein:
an area of the light spot pattern projected when a distance between the to-be-recognized palm and the image acquisition apparatus is a first distance is greater than an area of the light spot pattern projected when the distance between the to-be-recognized palm and the image acquisition apparatus is a second distance;
the first distance is less than the second distance; and
the area of the light spot pattern is an area proportion of the light spot pattern on the to-be-recognized palm.

13. The biometric recognition device according to claim 11, wherein:
a shape of a projection of the at least one light spot pattern on a plane is at least one of the following: a rectangle, a square, a triangle, or a circle.

14. The biometric recognition device according to claim 11, wherein:
the reflective array comprises at least one reflective array element and a driving circuit; and
the at least one reflective array element is connected to the driving circuit, and the driving circuit is configured to drive the at least one reflective array element to move, to adjust a direction of the reflected light.

15. The biometric recognition device according to claim 11, wherein:
the image acquisition apparatus further comprises at least one distance sensor,
the at least one distance sensor is located on one side of the imaging component, and
the at least one distance sensor is configured to detect a distance between the to-be-recognized palm and the reflective array and a distance between the to-be-recognized palm and the imaging component.

16. The biometric recognition device according to claim 15, wherein:
the at least one distance sensor is electrically connected to the light source, and
the light source is configured to adjust a light-emitting state according to at least one of the distance between the to-be-recognized palm and the reflective array or the distance between the to-be-recognized palm and the imaging component.

17. The biometric recognition device according to claim 15, wherein:
the at least one distance sensor is electrically connected to the reflective array, and
the reflective array is configured to adjust a reflection direction according to at least one of the distance between the to-be-recognized palm and the reflective array or the distance between the to-be-recognized palm and the imaging component.

18. The biometric recognition device according to claim 15, wherein:
the imaging component comprises an optical lens, a circuit board, and a photosensitive element,
the photosensitive element is electrically connected to the circuit board, and
the optical lens is located in a light entrance path of the photosensitive element.

19. The biometric recognition device according to claim 11, wherein:
the imaging component comprises an optical lens, a circuit board, and a photosensitive element,
the photosensitive element is electrically connected to the circuit board, and
the optical lens is located in a light entrance path of the photosensitive element.

20. The biometric recognition device according to claim 11, wherein the image acquisition apparatus further comprises:
an image processing circuit electrically connected to the imaging component,
wherein the image processing circuit is configured to receive the to-be-recognized image outputted by the imaging component and to determine a three-dimensional shape of the to-be-recognized palm according to deformation of the at least one light spot pattern in the to-be-recognized image.
